(19) United States
(12) Patent Application Publication
(10) Pub. No.: US 2006/0112017 A1
(43) Pub. Date: May 25, 2006

(54) System and method for auditing an electronic document trail

(76) Inventor: George Koppich, Irvine, CA (US)

Correspondence Address: TUCKER, ELLIS & WEST LLP, 1150 HUNTINGTON BUILDING, 925 EUCLID AVENUE, CLEVELAND, OH, 44115-1414, US

(21) Appl. No.: 10/994,863

(22) Filed: Nov. 22, 2004

(51) Int. Cl. G06F 17/60

(52) U.S. Cl. 705/58

(57) ABSTRACT

The subject invention is directed to a system and method for tracking the distribution and custody of a document. Glyph data, representing custody rules associated with an electronic document, is first generated and then associated with the electronic document, forming compound data. The compound data is then transmitted to a document processing device. The document processing device incorporates the glyph data, in a format visible to the human eye, into each page of the document being output. The glyph data contains custody rules regarding custody of the electronic document, as well as those hard copy printouts.

### BACKGROUND OF THE INVENTION

This invention is directed to a system and method for auditing an electronic document trail. More particularly, this invention is directed to a system and method for use with a document management system to track the distribution or custody of documents distributed outside of the document management system.

Document management systems allow users to generate documents and share or send these documents to other users, devices or systems. Often these documents are distributed in an electronic format or a printed format or both. Often the distribution of these documents to other users, devices, or system is performed with the understanding that the documents will not be distributed other than to selected parties. However, if a document is distributed outside of the selected parties or to the general public, there is little that may be done to enforce these informal distribution rules. It would be desirable to have a mechanism to mark or label a document in an inconspicuous way with the established distribution or custody rules. If the document were then located in the possession of an unauthorized party, the tracking data would be able to be read or extracted to identify the source of the disclosure.

This invention overcomes the aforementioned problems and provides a system and method for auditing an electronic document trail.

### SUMMARY OF THE INVENTION

In accordance with the present invention, there is provided a system and method for auditing an electronic document trail.

Further, in accordance with the present invention, there is provided a system and method use with a document management system to track the distribution or custody of documents distributed outside of the document management system.

Further, in accordance with the present invention, there is provided a system and method for marking or labeling documents in an inconspicuous way with the established distribution or custody rules.

Still further, in accordance with the present invention there is provided a system for auditing an electronic document trail. The system comprises glyph encoder means adapted for generating glyph data representative of custody rules associated with an electronic document and means adapted for associating the electronic document with the glyph data so as to form composite document data. The system also comprises means adapted for communicating the composite document data to an associated data output device for visual rendering thereof, wherein the visual rendering includes a visible rendering of a glyph image specified by the glyph data.

In a preferred embodiment, the system also comprises means adapted for receiving the glyph image and means adapted for extracting the custody rules from a received glyph image.

Preferably, the glyph encoder means includes means adapted for generating the glyph data so as to be generally undetectable by a human viewing the glyph image. In one embodiment, the glyph encoder means includes means adapted for generating the glyph data as a modification to at least one of font positioning, font size and font type in the glyph image. In another embodiment, the glyph encoder means includes means adapted for generating the glyph data as watermark. In yet another embodiment, the glyph encoder means includes means adapted for generating the glyph data so as to appear as a visual artifact.

In a preferred embodiment, the system further comprises means adapted for receiving, from at least one of an associated user and system administrator, data relating to parameters for the custody rules for an associated electronic document. Preferably, the data relating to the parameters for the custody rules for an associated electronic document include at least one of owner name of the electronic document, expiration date of electronic document, and rights associated with the electronic document.

Still further, in accordance with the present invention, there is provided a method for auditing an electronic document trail. The method comprises the steps of generating glyph data representative of custody rules associated with an electronic document and associating the electronic document with the glyph data so as to form composite document data. The method also comprises the step of communicating the composite document data to an associated data output device for visual rendering thereof, wherein the visual rendering includes a visible rendering of a glyph image specified by the glyph data. Preferably, the method further comprises the steps of receiving the glyph image; and extracting the custody rules from a received glyph image.

Preferably, the step of generating glyph data includes generating the glyph data so as to be generally undetectable by a human viewing the glyph image. In one embodiment, the step of generating glyph data includes generating the glyph data as a modification to at least one of font positioning, font size and font type in the glyph image. In another embodiment, the step of generating glyph data includes generating the glyph data as watermark. In yet another embodiment, the step of generating glyph data includes generating the glyph data so as to appear as a visual artifact.

In a preferred embodiment, the method further comprises the step of receiving, from at least one of an associated user and system administrator, data relating to parameters for the custody rules for an associated electronic document. Preferably, the data relating to the parameters for the custody rules for an associated electronic document include at least one of owner name of the electronic document, expiration date of electronic document, and rights associated with the electronic document.

These and other aspects, advantages, and features of the present invention will be understood by one of ordinary skill in the art upon reading and understanding the specification.

### BRIEF DESCRIPTION OF THE DRAWINGS

The subject invention is described with reference to certain parts, and arrangements to parts, which are evidenced in conjunction with the associated drawings, which form a part hereof and not, for the purposes of limiting the same in which:

FIG. 1 is a block diagram illustrative of the system of the present invention;

FIG. 2 is a flowchart illustrating the generation of distribution or custody rules of the present invention; and

FIG. 3 is a flowchart illustrating the extraction of distribution or custody rules according to the present invention.

### DETAILED DESCRIPTION OF THE PREFERRED EMBODIMENT

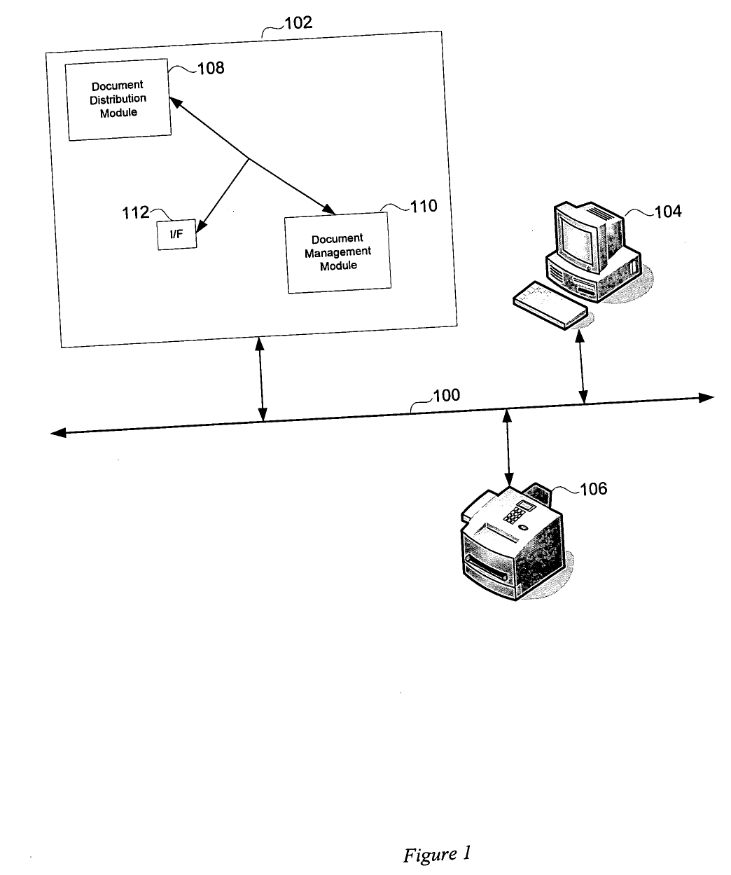

The present invention is directed to a system and method for use with a document management system to track the distribution or custody of documents distributed outside of the document management system. FIG. 1 is a block diagram illustrating a network environment for practicing the present invention is provided. The system comprises a data transport network 100 illustrative of a LAN or WAN environment. The network 100 is suitably any network and is preferably comprised of physical layers and transport layers, as illustrated by a myriad of conventional data transport mechanisms like Ethernet, Token-Ring™, 802.11(x), or other suitable wire-based or wireless data communication mechanisms as will be apparent to one of ordinary skill in the art.

Connected to a data transport network 100 is a document management system 102. The document management system is suitably operable to provide services to at least one computer 104, at least one image generating device 106. The document management system 102 is preferably a client/server system, which is suitably implemented in both single and collaborative corporate workgroups (although not limited to such environments). Also connected to data transport network 100 is computer 104.

The computer 104 is suitably either a server or client running on any OS, such as Windows NT, Windows 2000, Windows XP, Unix, Linux, Macintosh or other operating system.

At least one image generating device 106 is connected to data transport network 100. The image generating device is suitably any device capable of generating image outputs in a tangible medium, such as a printer, facsimile machine, scanning device, copier, multifunctional peripheral device, or other like peripheral devices. The image generating device 106 is suitably any networked image generating device as will be appreciated to one of ordinary skill in the art. The image generating device 106 preferably has an internal device controller suitably acting as a fully functional server with the necessary hardware and software that ensure proper operation of the image generating device as will be appreciated by those skilled in the art. In addition, the image generating device 106 preferably comprises an accessible storage medium, which is suitably a hard disk and random access memory as will be appreciated by those skilled in the art. Such storage medium is suitably integrated into the image generating device or disposed in an 110 associated medium associated therewith.

The document management system 102 preferably comprises a document distribution means 108 and a document management means 110. The main function of the document management means 110 is to store documents in a centralized or jointly accessible document repository and to facilitate user capability to modify documents, collaborate during document editing, and search and locate stored documents. The main function of the document distribution means 108 is to route jobs to their destinations such as image generating devices, servers, computers, a document repository, etc.

The document management system 102 preferably interfaces with data transport network 100 via network interface 112. Thus, the document management system 102, computer 104 and at least one image generating device 106 are in shared communication.

The document management system is also in data communication with tracking data generator, such as a glyph encoder means adapted to generate glyph data representative of custody or distribution rules for an associated electronic document. The encoder means are any suitable means known in the art for generating such data. Suitable means or devices include, but are not limited to, encoding subtle changes in font, text type, text sizes, spacing, color, indentations, or generation of seemingly random or superfluous markings or watermarks. In one embodiment, the glyph encoder means are associated or part of the image generating device 106 and the glyph data is generated as part of the image generation process. In another embodiment, the glyph encoder means are a separate component and in data communication with the image generating device and transmit the generated glyph data to the image generating device. Thus the tracking generator includes means adapted for acquiring data representative of a document history, and means adapted to encode such information in an innocuous way as noted above.

The document management system is in data communication with means adapted to receive the glyph data and extract the glyph data for interpretation thereof. In one embodiment, such means are incorporated or part of the glyph encoder means as shown. In another embodiment, such means are a separate component. The glyph data is received at such means via any suitable means. For example, a document containing the glyph data is suitably transmitted to such means and the glyph data is interpreted to determine the custody rules.

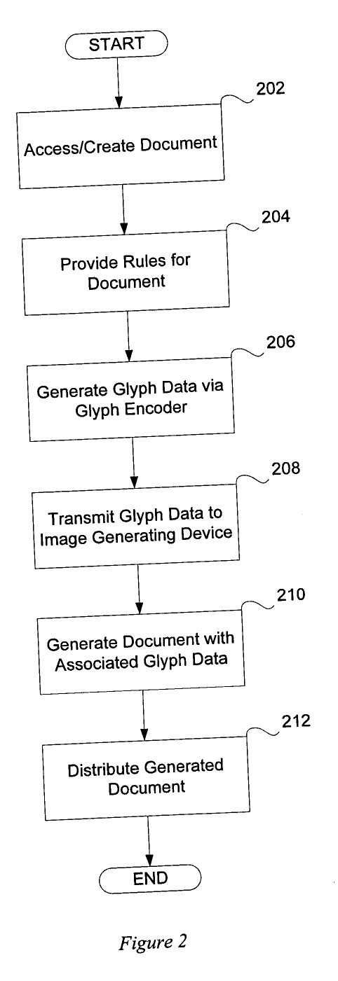

FIG. 2 is a flowchart illustrating the method for generating the glyph data according to the present invention. At 202, the user accesses or creates a document to be distributed via any suitable means. For example, in one embodiment, the user accesses or creates the document via a user interface on the computer 104. In another embodiment, the user accesses the document via a user interface associated with the image generating device or transmits the document to the image generating device via any suitable means.

At 204, the user or a system administrator provides the custody or distribution rules for the document via any suitable means. In one embodiment, the custody rules are entered via a user interface at the computer. In another embodiment, the custody rules are entered via a user interface associated with the image generating device. The custody rules include at least one of the user or system administrator name, expiration date of the custody rules, and the rights to be given, such as whether copies may be made, in what form the document may be distributed, and if the document may be modified, and the parties allowed such rights.

At 206, the glyph data is generated containing the selected custody rules by the glyph encoder means. At 208, the glyph data is transmitted to the image generating device and associated with the document to which it pertains via any suitable means. At 210, the selected document with the glyph data is generated.

Preferably, the glyph data is generated with the document such that is generally undetectable by a human eye. In one embodiment, the glyph data is generated such that appears as a modification to at least one of font positioning, font size and font type in the glyph image on the document. In another embodiment, the glyph data is generated such that it appears as a watermark on the document. In yet another embodiment, the glyph data is generated such that is appears as a visual artifact on the document.

At 212, the document containing the glyph data is then distributed to other parties via any suitable means.

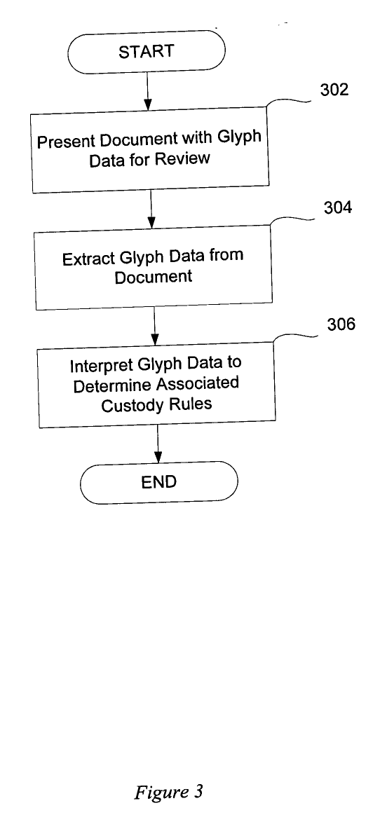

FIG. 3 is a flowchart illustrating the extraction of the distribution or custody rules from a document containing such data. At 302, a document containing glyph data setting forth the custody rules is presented via any suitable means for review. At 304, the glyph data is extracted from the document via any suitable means. Suitable means are provided for an intelligent reader system, pre-programmed with corresponding intelligence to recognize a presence of glyph data in a tangible document, and decoding document history data therefrom. At 306, the glyph data is interpreted to determine the custody rules for the associated document.

While in the preferred embodiment the present invention is implemented in software, as those skilled in the art can readily appreciate it may also be implemented in hardware or a combination of software and hardware.

Although the preferred embodiment has been described in detail, it should be understood that various changes, substitutions, and alterations can be made therein without departing from the spirit and scope of the invention as defined by the appended claims. It will be appreciated that various changes in the details, materials and arrangements of parts, which have been herein described and illustrated in order to explain the nature of the invention, may be made by those skilled in the area within the principle and scope of the invention as will be expressed in the appended claims.

What is claimed:

1. A system for auditing an electronic document trail comprising:
glyph encoder means adapted for generating glyph data representative of custody rules associated with an electronic document;
means adapted for associating the electronic document with the glyph data so as to form composite document data; and
means adapted for communicating the composite document data to an associated data output device for visual rendering thereof, wherein the visual rendering includes a visible rendering of a glyph image specified by the glyph data.

2. The system for auditing an electronic document trail of claim 1 further comprising:
means adapted for receiving the glyph image; and
means adapted for extracting the custody rules from a received glyph image.

3. The system for auditing an electronic document trail of claim 1 wherein the glyph encoder means includes means adapted for generating the glyph data so as to be generally undetectable by a human viewing the glyph image.

4. The system for auditing an electronic document trail of claim 3 wherein the glyph encoder means includes means adapted for generating the glyph data as a modification to at least one of font positioning, font size and font type in the glyph image.

5. The system for auditing an electronic document trail of claim 3 wherein the glyph encoder means includes means adapted for generating the glyph data as watermark.

6. The system for auditing an electronic document trail of claim 3 wherein the glyph encoder means includes means adapted for generating the glyph data so as to appear as a visual artifact.

7. The system for auditing an electronic document trail of claim 1 further comprising means adapted for receiving, from at least one of an associated user and system administrator, data relating to parameters for the custody rules for an associated electronic document.

8. The system for auditing an electronic document trail of claim 7 wherein the data relating to the parameters for the custody rules for an associated electronic document include at least one of owner name of the electronic document, expiration date of electronic document, and rights associated with the electronic document.

9. A method for auditing an electronic document trail comprising the steps of:
generating glyph data representative of custody rules associated with an electronic document;
associating the electronic document with the glyph data so as to form composite document data; and
communicating the composite document data to an associated data output device for visual rendering thereof, wherein the visual rendering includes a visible rendering of a glyph image specified by the glyph data.

10. The method for auditing an electronic document trail of claim 9 further comprising the steps:
receiving the glyph image; and
extracting the custody rules from a received glyph image.

11. The method for auditing an electronic document trail of claim 9 wherein the step of generating glyph data includes generating the glyph data so as to be generally undetectable by a human viewing the glyph image.

12. The method for auditing an electronic document trail of claim 11 wherein the step of generating glyph data includes generating the glyph data as a modification to at least one of font positioning, font size and font type in the glyph image.

13. The method for auditing an electronic document trail of claim 11 wherein the step of generating glyph data includes generating the glyph data as watermark.

14. The method for auditing an electronic document trail of claim 11 wherein the step of generating glyph data includes generating the glyph data so as to appear as a visual artifact.

15. The method for auditing an electronic document trail of claim 9 further comprising the step of receiving, from at least one of an associated user and system administrator, data relating to parameters for the custody rules for an associated electronic document.

16. The method for auditing an electronic document trail of claim 15 wherein the data relating to the parameters for the custody rules for an associated electronic document include at least one of owner name of the electronic document, expiration date of electronic document, and rights associated with the electronic document.

17. A computer-readable medium for auditing an electronic document trail comprising:
instructions for generating glyph data representative of custody rules associated with an electronic document;
instructions for associating the electronic document with the glyph data so as to form composite document data; and
instructions for communicating the composite document data to an associated data output device for visual rendering thereof, wherein the visual rendering includes a visible rendering of a glyph image specified by the glyph data.

18. The computer-readable medium for auditing an electronic document trail of claim 1 further comprising:
instructions for receiving the glyph image; and
instructions for extracting the custody rules from a received glyph image.

19. The computer-readable medium for auditing an electronic document trail of claim 18 wherein the instructions for generating the glyph data include instructions for generating the glyph data so as to be generally undetectable by a human viewing the glyph image.

20. The computer-readable medium for auditing an electronic document trail of claim 19 wherein the instructions for generating the glyph data includes instructions for generating the glyph data as a modification to at least one of font positioning, font size and font type in the glyph image.

21. The computer-readable medium for auditing an electronic document trail of claim 19 wherein the instructions for generating the glyph data include instructions for generating the glyph data as watermark.

22. The computer-readable medium for auditing an electronic document trail of claim 19 wherein the instructions for generating the glyph data include instructions for generating the glyph data so as to appear as a visual artifact.

23. The computer-readable medium for auditing an electronic document trail of claim 17 further comprising means adapted for receiving, from at least one of an associated user and system administrator, data relating to parameters for the custody rules for an associated electronic document.

24. A computer-implemented method for auditing an electronic document trail comprising the steps of:
generating glyph data representative of custody rules associated with an electronic document;
associating the electronic document with the glyph data so as to form composite document data; and
communicating the composite document data to an associated data output device for visual rendering thereof, wherein the visual rendering includes a visible rendering of a glyph image specified by the glyph data.

25. The computer-implemented method for auditing an electronic document trail of claim 24 further comprising the steps:
receiving the glyph image; and
extracting the custody rules from a received glyph image.

26. The computer-implemented method for auditing an electronic document trail of claim 24 wherein the step of generating glyph data includes generating the glyph data so as to be generally undetectable by a human viewing the glyph image.

27. The computer-implemented method for auditing an electronic document trail of claim 26 wherein the step of generating glyph data includes generating the glyph data as a modification to at least one of font positioning, font size and font type in the glyph image.

28. The computer-implemented method for auditing an electronic document trail of claim 26 wherein the step of generating glyph data includes generating the glyph data as watermark.

29. The computer-implemented method for auditing an electronic document trail of claim 26 wherein the step of generating glyph data includes generating the glyph data so as to appear as a visual artifact.

30. The computer-implemented method for auditing an electronic document trail of claim 24 further comprising the step of receiving, from at least one of an associated user and system administrator, data relating to parameters for the custody rules for an associated electronic document.
